(19) United States
(12) Patent Application Publication
(10) Pub. No.: US 2013/0060580 A1
(43) Pub. Date: Mar. 7, 2013

(54) Automated System for Monitoring Mental Status of Individuals Receiving Outpatient Mental Health Treatment

(71) Applicants: A. Bradley Chapman, Alexandria, VA (US); Raymond D. Kester, Fairfax Station, VA (US)

(72) Inventors: A. Bradley Chapman, Alexandria, VA (US); Raymond D. Kester, Fairfax Station, VA (US)

(21) Appl. No.: 13/603,888

(22) Filed: Sep. 5, 2012

Related U.S. Application Data
(60) Provisional application No. 61/531,269, filed on Sep. 6, 2011.
(60) Provisional application No. 61/654,337, filed on Jun. 1, 2012.

(51) Int. Cl. G06Q 50/22; G06Q 50/24

(52) U.S. Cl. 705/3; 705/2

(57) ABSTRACT

A computerized system useable in methods for monitoring mental health status of individuals receiving outpatient mental health treatment during the time periods between office visits with the doctor. The computerized system is particularly useful to the doctor to see a graph of a parameter on which survey responses have been collected from the patient between office visits and onto which graph the automated system has overlaid a history of medication changes.

### RELATED APPLICATIONS

This application claims benefit of U.S. provisional patent application No. 61/531,269 filed Sep. 6, 2011 and U.S. provisional patent application No. 61/654,337 filed Jun. 1, 2012.

### FIELD OF THE INVENTION

This invention relates to mental health treatment, especially outpatient mental health treatment.

### BACKGROUND OF THE INVENTION

In the United States, for psychiatrists seeing patients, typically a full-length visit comprises 45 minutes with a patient in the psychiatrist's office, as well as other office visits in which 15 minutes' time is allotted to the doctor to evaluate and treat the patient. On average, a mental health practitioner sees between 15-25 patients a day. One psychiatrist usually has hundreds of patients under his care.

Typically a patient is seen by the mental health professional on a weekly, biweekly, or monthly or 3-month interval. During the session, the mental health professional asks the patient a series of questions regarding how they have been doing in relationship to the symptoms and problems for which the psychiatrist is treating them.

Major challenges are presented in outpatient psychiatric practice because many pertinent developments may be occurring when the patient is not in the office, but unknown to the psychiatrist. Psychiatrists, and other mental health professionals such as psychologists, face major challenges in gathering pertinent information regarding the patient's symptoms and the patient's functioning during the time the doctor is not seeing them from their last visit to the doctor.

Unmet needs exist for tools to assist and support psychiatrists and other mental health care providers in provision of outpatient mental health treatment at a time when the insurance companies are reducing the time and frequency that the doctor may see his patients and the time he spends with each patient.

### SUMMARY OF THE INVENTION

The present invention allows a mental health professional to monitor the mental health state of one or more individuals that the mental health professional is treating, on an ongoing and accurate basis between their office visits to the doctor, in a way that improves the quality of care and that saves the mental health professional many hours of professional time, alerts the mental health professional to emergency situations, and assists the mental health professional in keeping accurate electronic records of the patient's progress and makes available to the mental health professional crucial information about the patient's symptoms and problems that is unavailable to the professional in the conventional system of psychiatric care.

An inventive system automatically sends the patient (client) a series of probes delivered to the patient's email address on a schedule (such as, e.g., on a schedule determined by the mental health professional treating the patient); after a probe is sent to a patient, automatically receives back from the patient data responsive to the probe; and automatically gathers data and presents the gathered data in a format viewable by the mental health professional.

The invention in a certain preferred embodiment provides a method for a detailed monitoring of a mental health status, during an interim period between visits to a mental health professional, of a caseload of individual patients who are outpatients of the mental health professional, comprising steps performed by an automated system comprising at least one computer or machine, of: receiving into the automated system, via a portal accessed by the mental health professional, a schedule for each patient of a frequency at which the automated system is to send a probe to the patient; maintaining, by the automated system, a table in which each patient in the caseload has an entry for the frequency at which the automated system is to send a probe to the patient; updating the table, performed by the automated system, based on the schedule received in the receiving step; and, according to the sending-frequency table, selectively sending, performed by the automated system, a probe including at least one question and a set of predefined answers each of which is selectable, to a remote device associated with a patient, and repeating the selectively sending step for other patients within the caseload, such as, e.g., inventive methods further comprising a step, performed by the automated system, of receiving back from the patient an answered probe; inventive methods further comprising a step, performed by the automated system, of storing the answered probe; inventive methods further comprising a step, performed by the automated system, of receiving a request from the mental health professional to view a summary for a patient, wherein the summary is based on at least one answered probe received back from the patient; inventive methods further comprising a step, performed by the automated system, of screening the answered probe against a predetermined alarm criterion, wherein the screening is performed in real-time upon receiving back the answered probe; inventive methods further comprising a step, performed by the automated system, of, when the predetermined alarm criterion is found in the answered probe, immediately transmitting an alarm; inventive methods further comprising steps performed by the automated system of providing, for a particular patient, a menu of selectable tracking parameters to the mental health provider, and receiving as input from the mental health provider a selection of a subset of the provided parameters, followed by storing the subset of parameters in a file for the patient, and when sending probes to the patient, including only questions based on the subset of parameters for the patient; inventive methods further comprising steps performed by the automated system of: storing, in a patient names database, names of patients of the mental health professional; storing, for each patient in the patient names database, medications and changes data; storing, for each patient in the patient names database, medication list data comprising a medication list; storing, for each patient in the patient names database, a parameters list which comprises a set of parameters selected by the mental health professional and which are to be addressed by the probes sent to the patient; storing, for each patient in the patient names database, parameters data which resulted from probes sent to the patient; and receiving a selection from the mental health professional of a particular selected patient name and a particular selected parameter, followed by generating a screen display for the selected patient name depicting a plotted graph for the selected parameter; inventive methods comprising a step, performed by the automated system, of displaying medication change data on the display screen wherein each displayed medication change data display is oriented along a time-axis of the display screen to appear exactly on the time-axis according to a date of the medication change being displayed; inventive methods comprising a step performed by the automated system, of sending an alert to the physician when a patient has had an alarm generated, wherein the alert sent to the physician either identifies the patient or permits the physician to gain access to the identity of the patient; and other inventive methods.

In another preferred embodiment the invention provides a mental health patient alert method performed by a computerized mental health patient alert system, comprising steps, performed by the system, of: surveying a patient according to a survey schedule wherein the patient is surveyed between office visits; collecting a set of responses by the patient obtained through the surveying step; storing patient-specific historical data and current data for medications taken by the patient; based on the survey responses collected from the patient for a first parameter and on the stored patient-specific data, plotting a patient-specific graph covering a period of time for the first parameter and overlaying at least one medication change indicator onto the plotted graph; and outputting the plotted patient-specific graph for the first parameter with the overlaid medication change indicator to an electronic device that is viewed by a mental health professional who is responsible for the patient; such as, e.g., inventive methods comprising a step performed by the automated system, of sending an alert to the physician when a patient has had an alarm generated, wherein the alert sent to the physician either identifies the patient or permits the physician to gain access to the identity of the patient; and other inventive methods.

### BRIEF DESCRIPTION OF THE DRAWINGS

FIGS. 1-3A are examples of graphs displayed on a mental health professional's computer screen in inventive embodiments, in which:

FIG. 1 is a graph of survey data for how happy the patient has been feeling lately, surveyed from the patient, over a period of time;

FIG. 1A is a graph of survey data for how happy the patient has been feeling lately, surveyed from the patient, over a period of time with overlaid illustrations of where medication changes occurred for Cymbalta;

FIG. 2 is a graph of survey data for how the patient's sleep has been, surveyed from the patient, over a period of time;

FIG. 2A is a graph of survey data for how the patient's sleep has been, surveyed from the patient, over a period of time with overlaid illustrations of where medication change occurred for Ambien, Lunesta and Trazodone;

FIG. 3 is a graph of survey data for how much stress the patient has been under, surveyed from the patient, over a period of time;

FIG. 3A is a graph of survey data for how much stress the patient has been under, surveyed from the patient, over a period of time with overlaid illustrations of where medication change occurred for Xanax.

FIG. 4 depicts an inventive automated system 100 in an exemplary embodiment.

FIG. 5 depicts a diagram for generation of an inventive screen display generated by an inventive automated system.

FIGS. 6-6B are diagrams of an inventive embodiment of a questionnaire and survey report system, with FIG. 6A corresponding to the top of FIG. 6 and focusing on the health professional side, and FIG. 6B corresponding to the bottom of FIG. 6 and focusing on the patient side.

FIG. 7 is a diagram of an inventive embodiment of a mental health patient alert system.

FIG. 8 is a flow chart corresponding to the inventive mental health patient alert system in FIG. 7.

FIG. 9 is a flow chart of another embodiment of a mental health patient alert system according to the invention.

FIGS. 10-12 are flow charts of exemplary modules according to embodiments of the invention, including an exemplary Questionnaire module in FIG. 10, an exemplary Scheduler & Notifier Module in FIG. 11 and an exemplary Patient Record Module in FIG. 12.

FIG. 13 depicts exemplary sample questionnaire screens generated by an inventive system in an embodiment.

### DESCRIPTION OF A PREFERRED EMBODIMENT

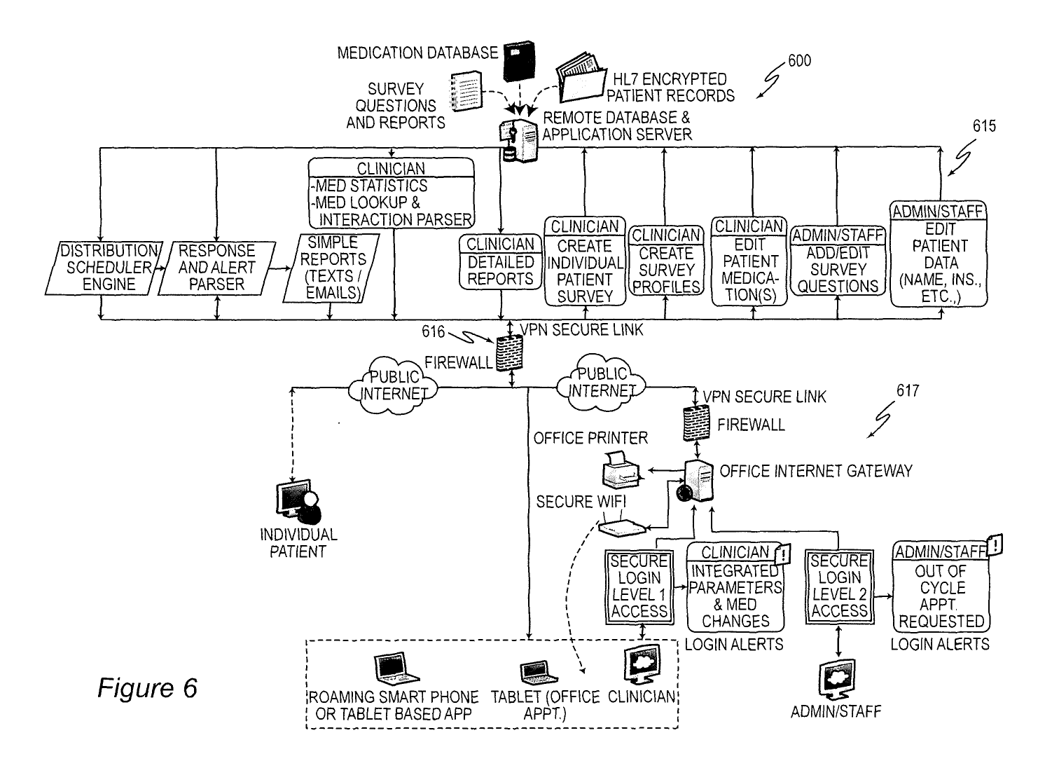

An inventive computerized system 100 (FIG. 4) preferably includes at least one portal 1 (which is a computer or machine such as a personal computer, a laptop computer, a portable device, etc.) that is accessed by the patient's mental health professional (DOC in FIG. 4) and that receives as input a schedule of when probes are to be sent by the system 100 to the patient. With regard to a schedule for the series of probes, an example of a schedule determined by the mental health professional treating the patient is, e.g., a schedule that has been determined based on the mental health professional's opinion of the patient's mental health state. In a preferred example of using the invention, a mental health professional customizes, on a patient-by-patient basis, the schedule that is input into the inventive system 100 according to the patient's clinical state. Examples of a schedule for sending probes are, e.g., daily, weekly, biweekly, monthly, other schedule input by the mental health professional, etc.

Reference herein to a patient's mental health state, is to an opinion of the patient's mental health professional of the patient's mental health state, such as, e.g., a professional judgment, opinion or view that is the thinking of the professional including thinking regardless of whether reduced to a tangible medical record or not.

In a preferred example, the portal 1 displays a computer screen to the mental health provider which includes an input field that receives a patient name (and/or patient identification number) as entered by the mental health provider, and after the system 100 has received an entered patient name and/or identification number, the portal 1 displays to the mental health provider a schedule-receiving screen that receives from the mental health provider a frequency indication, such as a schedule-receiving screen that asks a physician to select “weekly” or “daily”.

The inventive automated system 100 includes data storage or memory 2 which is in electronic communication with portal 1. In the data storage/memory 2 preferably is stored at least one probe and a probe-sending table comprising patient-by-patient entries wherein each patient entry comprises a sending frequency instruction.

The inventive automated system 100 includes a sender 3 which is in electronic communication with data storage/memory 2. Sender 3 retrieves the probe stored in data storage 2 and automatically sends out the probe according to the probe-sending table, selectively to a set of email addresses each email address being associated with a respective remote device R1 . . . n (such as a personal computer, a Blackberry, an iPhone, etc.), wherein each respective remote device R1 . . . n is associated with a respective patient P1 . . . n.

For automatically sending out the probe, preferably an automated system is used, such as a survey platform. For example, a survey platform that is commercially available can be customized by changing content of the questions that are asked, and modified so that each recipient receives questions customized to him.

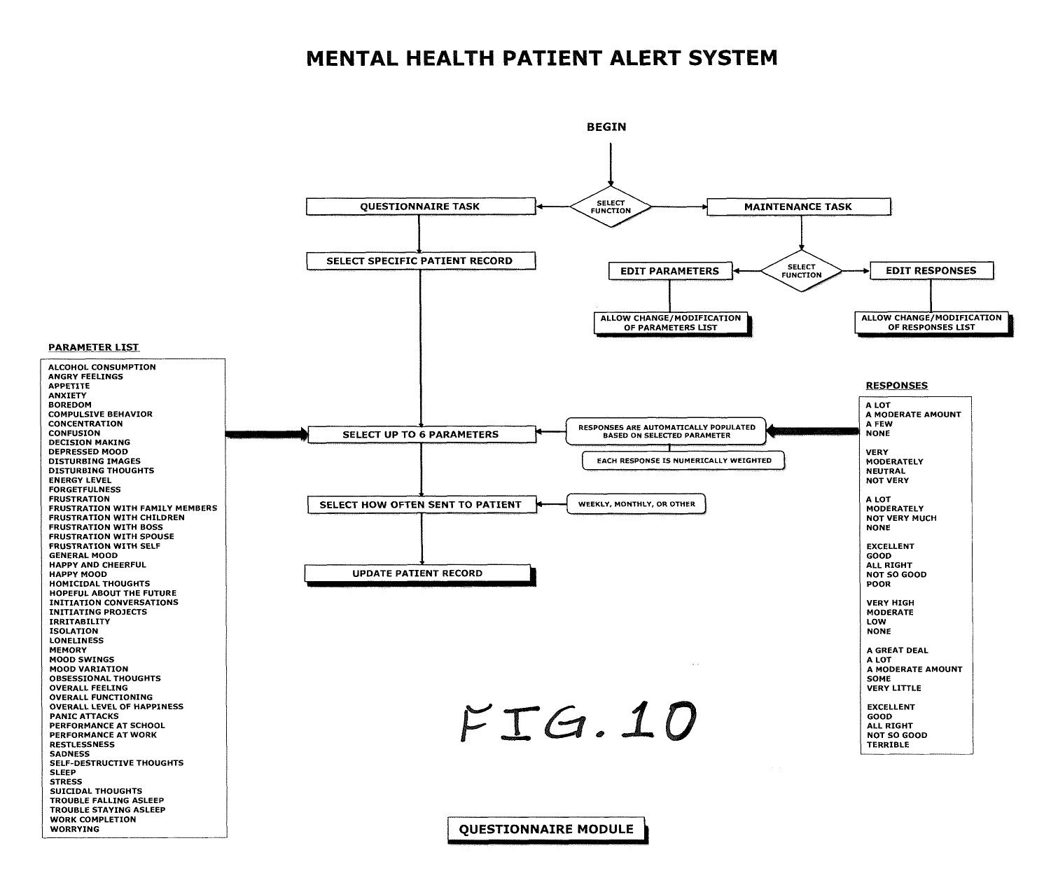

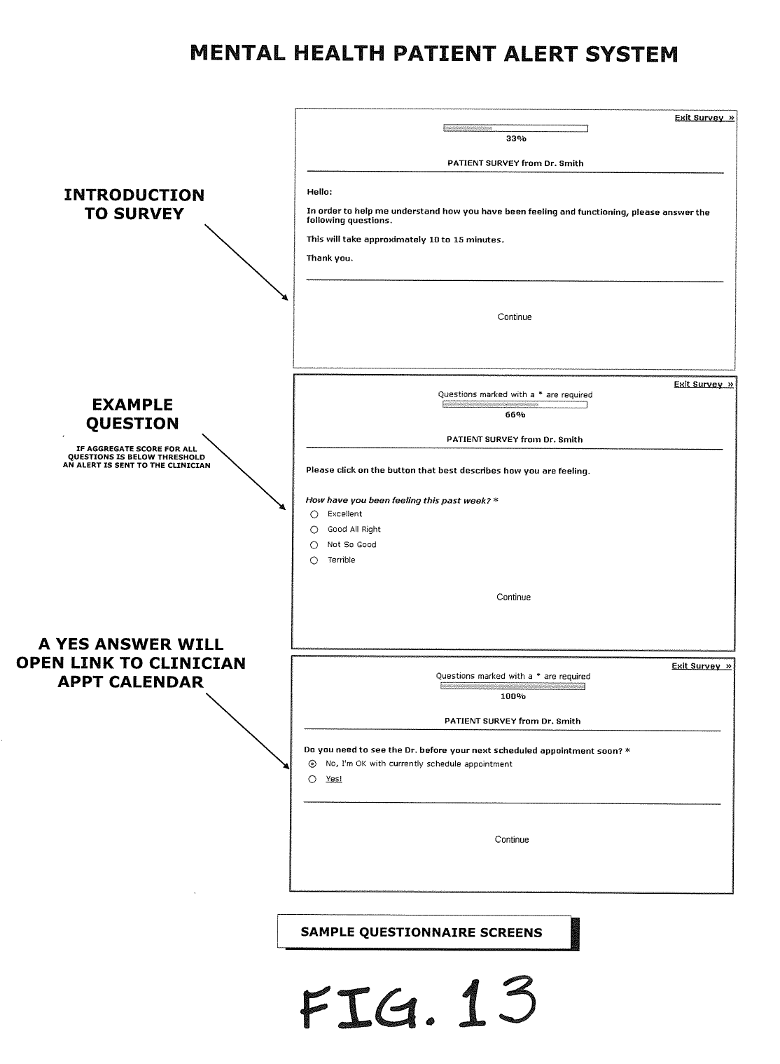

For example, a survey screen (such as, e.g., a survey screen illustrated in FIG. 13) preferably is generated when a process (such as, e.g., a process performed according to FIG. 10) is performed by an inventive computer system.

After a patient P1 has noticed that the probe has been received on his remote device RD1, and after the patient P1 has answered questions in the probe, data from patient P1 is transmitted back to data receiver 4, which updates data storage 2. The updated data for patient P1 in data storage 2 is then available for DOC to review.

Preferably the inventive system 100 comprises a screener (such as, e.g., a screener within data receiver 4, a screener other than data receiver 4, etc.) that screens the received data in real-time according to a stored instruction for presence of a predetermined indication needing immediate attention (such as, e.g., a response in which a patient indicated having had suicidal thoughts, etc.). If such screening is performed by a screener, when the inventive system detects an indication needing immediate attention, then the system 100 immediately, in real-time, transmits an electronic alarm (such as an alarm transmitted to portal 1, an alarm transmitted to the doctor's cellular phone, an alarm transmitted to a plurality of destinations, etc.). When the system 100 issues an alarm, preferably alarm issuance is persistently repeated by the system until the doctor acknowledges receipt and clears the alarm.

As a probe sent by the inventive automated system 100 to a patient, a preferred example is, e.g., an email that is sent to the patient, preferably an email containing one or more questions (such as, e.g., questions concerning the patient's mental or emotional state) for the patient to answer. A preferred example of how much time would be needed by the patient to answer the questions in a probe is, e.g., a time in a range of about 10-15 minutes of the patient's time. A preferred example of a number of questions in a probe sent to a patient, is, e.g., a number of questions in a range of about 10-30 questions.

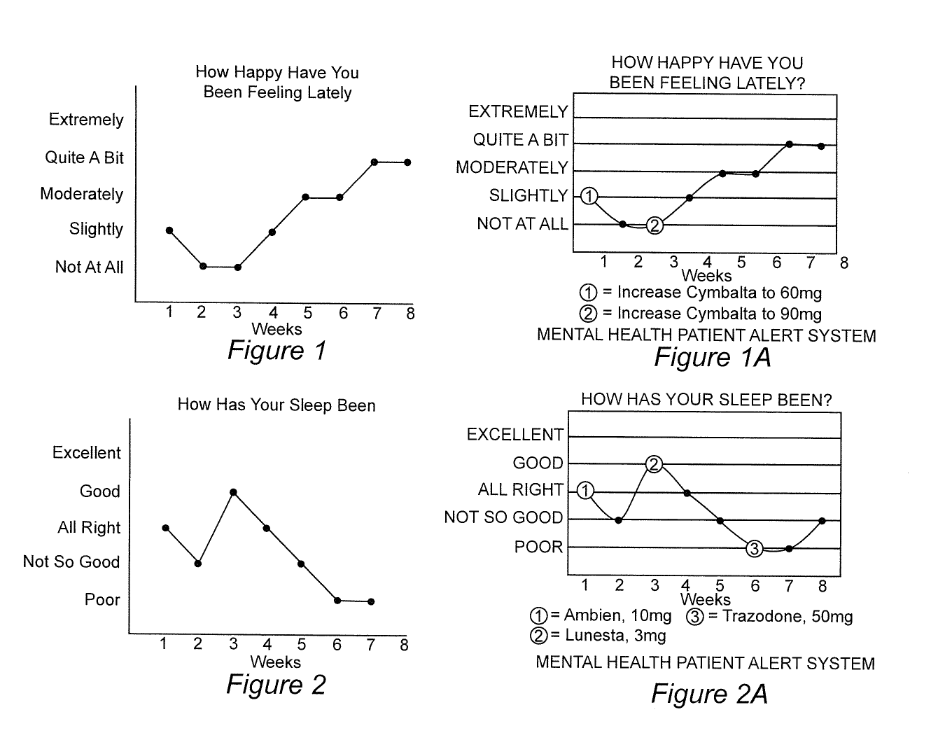

The automated system 100 gathers data from the patient in response to the probe, and maintains the gathered data. The automated system 100 makes the gathered data available to the mental health practitioner such as, e.g., by outputting a display (such as, e.g., a graphic display, a numeric display, etc.) to the mental health practitioner. Preferably the display is a display specific to one patient and that depicts the patient's progress over one or more pre-selected monitoring time periods. Non-limiting examples of a display that is outputted by an inventive computer system are illustrated in FIGS. 1-3A, such as, e.g., a graph of survey responses from a patient surveyed on one particular parameter (such as, e.g. a parameter of “How happy have you been feeling lately?”) at particular times over a period of time (such as, e.g., over a period of weeks) wherein the patient responses are finite choices from among a set of finite choices given by the automated survey (such as, e.g., a set of choices consisting of “Not At All”, “Slightly”, “Moderately”, “Quite a bit” and “Extremely”).

It is particularly preferred for the inventive automated system to overlay at least one medication change onto the graph when graphing survey response data received from a patient. Examples of overlaying at least one medication change onto the graph are, e.g., overlaying at least one medication change onto the graph in a form of a ball or dot (such as a ball or dot for which a legend “MED Change” is also displayed by the system onto or nearby the graph); overlaying at least one medication change onto the graph in a form of a circled number, circled letter or circled symbol for which number, letter or symbol a legend is also displayed by the system on or near the graph; etc. Non-limiting examples of using a circled number to overlay a medication change are illustrated in FIGS. 1A, 2A and 3A.

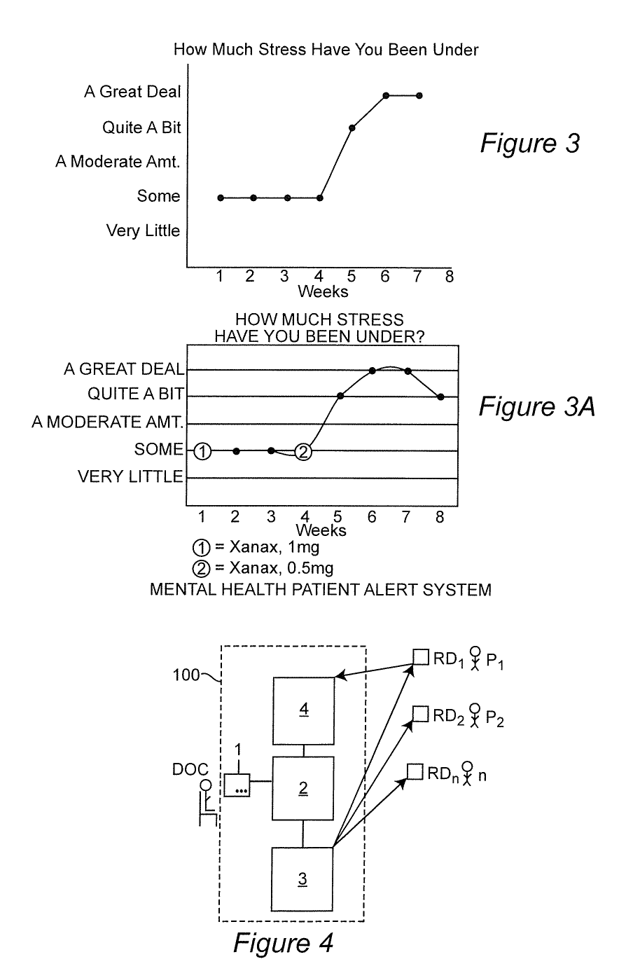

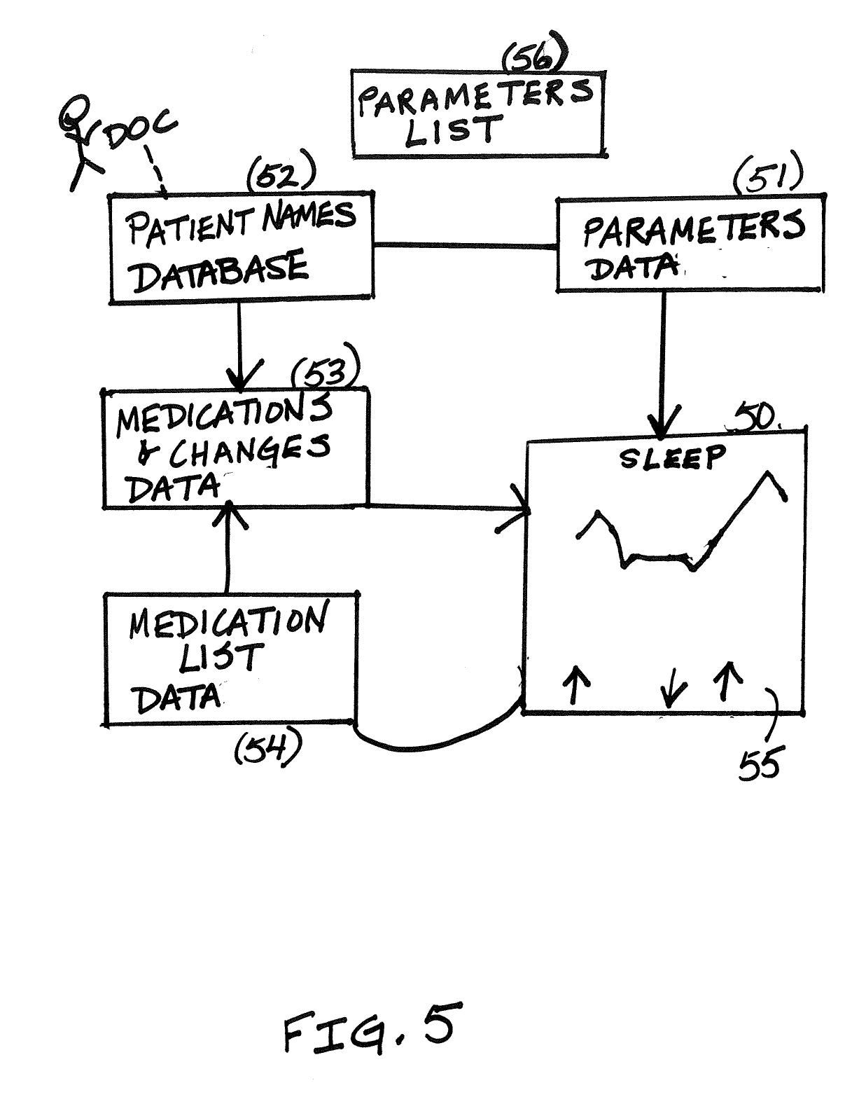

It should be appreciated that FIGS. 1A, 2A and 3A are representative and may be modified within the scope of the invention. Namely, the parameter “How happy have you been feeling lately?” that is shown on FIG. 1A, the parameter “How has your sleep been?” that is shown on FIG. 2A, and the parameter “How much stress have you been under?” that is shown on FIG. 3A, each is representative of a parameter generally; the indication “increase” shown on FIG. 1A is representative of a change generally which could be “increase” or “decrease”; the medication Cymbalta shown on FIG. 1A, the medication Ambien shown on FIG. 2A, the medication Luneseta shown on FIG. 2A, the medication Trazodone shown on FIG. 2A, and the medication Xanax shown on FIG. 3A, each is representative of a medication generally; the dosages 60 mg and 90 mg shown FIG. 1A, the dosages 10 mg, 3 mg and 50 mg shown on FIG. 2A, and the dosages 1 mg and 0.5 mg are representative and the dosage amount could be otherwise; etc. It will be appreciated that the substantive information (such as, e.g., medication, dosage, change date, etc.) displayed on a graph for a particular patient at a particular time is a function of the actual medication history for the particular patient as stored in the inventive automated system.

For a question contained in the probe, preferably the question is accompanied by a predefined set of selectable answers, such as, e.g., a question “How happy have you been feeling lately?” with pre-defined patient-selectable answers “extremely”, “quite a bit”, “modestly”, “slightly” and “not at all”; a question “How has your sleep been?” with pre-defined patient-selectable answers “excellent”, “good”, “all right”, “not so good”, and “poor”; a question “How have you been functioning at work/school?” with a pre-defined set of patient-selectable answers “excellent”, “good”, “all right”, “not so good” and “poorly”; a question “How much stress have you been under?” with a pre-defined set of patient-selectable answers “a great deal”, “a lot”, “a moderate amount”, “some” and “very little”; a question “Have you had any suicidal thoughts lately?” with a pre-defined set of patient-selectable answers “None”, “A few”, and “A lot”; etc.

Use of the inventive methods and systems will save the mental health professional a great deal of time in assessing the patient's clinical state and progress. For example, in order to track a patient's progress in the traditional manner, the mental health professional would have to spend approximately 30 minutes reviewing the patient's paper chart and his patient progress notes each time the patient comes in for a visit. By using the invention, the doctor need only pull the patient's data up on the doctor's computer, which would take less than a minute.

The invention is useful to give the mental health professional a much more accurate picture of the patient's clinical state and progress by displaying to the mental health professional a graph (see, e.g., FIGS. 1-3A) of the patient's progress on the mental health professional's computer screen.

On average, a mental health practitioner sees between 15-25 patients daily, so that use of the invention presents an opportunity for saving about 450 minutes of professional time daily, which is a very significant time-savings.

Also, importantly, the frequent sampling of the patient's mental state when the inventive automated system is used will improve quality of treatment that the patient is receiving, because typically a patient is seen by the mental health provider on a biweekly, or monthly or 3-month interval. Compared to not using the invention and having to rely on asking the patient a series of questions during the session regarding how the patient has been doing lately, the invention gives the doctor a much more accurate picture of the patient's clinical state with a sequential picture of the patient's progress and course with many additional probes of the patient's mental state which significantly improves the care the patient is receiving.

Also in terms of improving patient care, when a patient is having suicidal thoughts, the inventive system automatically alerts the doctor , which allows the doctor to respond immediately and make an intervention. The probes of a patient's clinical state can be sent daily by the automated system if necessary.

Also, in recent years there has developed a very strong trend, in a context of improving patient care, to record the patient's clinical state and progress in an electronic manner rather than on paper. The present invention is useable in the Medicare context and solves problems raised by Medicare mandates requiring electronic records of the patient's care that will affect millions of patients.

Use of the invention provides several advantages. Advantageously, crucial data regarding the patient's symptoms and problems is obtained in a real-time manner that makes the data available to the doctor much more accurate and with numerous sample measurements giving the doctor a much clearer view of the course of the patient's symptoms. The invention advantageously can be used to allow the doctor to customize the parameters that are monitored to each individual patient in an easy manner, such by selecting for example 10 out of 50 presented symptoms and problems from a menu presented to him. Advantageously, the invention can be used so that the doctor can easily add to the monitored problems list any parameter that the doctor would like to monitor. Advantageously, the cause of each patient's monitored problems can be easily displayed for viewing by the doctor on a graphic chart that makes interpreting the patient's progress much clearer than simply looking at individual reports.

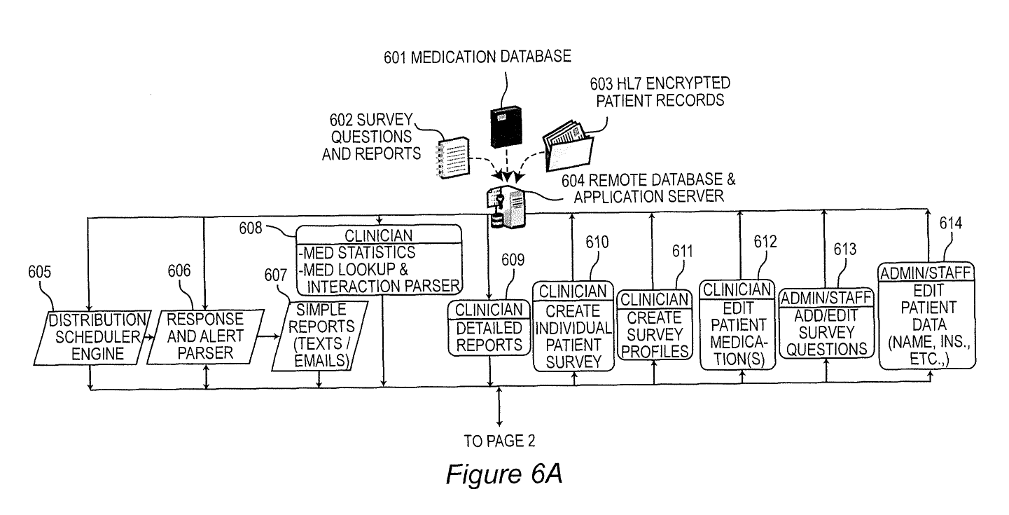

Preferably the invention is used to generate an inventive screen display such as screen display 50 for a particular parameter, such as sleep, from the stored parameters data 51, with a plotted curve for a particular patient name from the patient names database 52. The patient names database 52 stores names of patients of a doctor (DOC) to whom the patient names database 52 is accessible. An inventive automated system used in FIG. 5 presents a portal to receive from the doctor (DOC) a selection of particular patient name from the patient names database 52. The automated system comprises medications and changes data 53 (stored in computer-readable form) that is accessible to the doctor DOC, and medication list data 54 (stored in computer-readable form) that is accessible to the doctor (DOC).

Stored medications and changes data 53 comprise, for each patient, data specific to medications taken by that patient, and, for each medication taken by the patient, historical data relating to the medication (such as, e.g., dosage, date of change of dosage, etc.). A psychiatric patient typically has multiple medications, and stored data 53 preferably is stored in a database (or linked databases) that accommodate records on a patient-by-patient basis, wherein each patient has a plurality of medications each of which medication has a set of linked or associated data.

Stored medications list data 54 comprises data records, on a patient-by-patient basis, that represent what medications are, or have been, taken by a particular patient.

In FIG. 5, “sleep” is depicted in screen display 50 for illustration purposes, and likewise any other parameter could be represented. On screen display 50, the x-axis represents time (such as in days or weeks); the y-axis represents a value of how the patient is doing for the displayed parameter, such as for sleep. Screen display 50 comprises a visual-indicator section 55 that comprises visual indicators (such as arrows, or other visual indicators), wherein each arrow represents a medication change date. In screen 50, visual-indicator section 55 is at the bottom of the screen below the plotted “sleep” curve, but it will be appreciated that section 55 could be positioned in other placements.

For each patient, a parameters list 56 is stored by the automated system, and the stored parameters list 56 is accessible by the doctor DOC. The doctor can select, for a particular patient from the patient names database 52, a particular parameter from the parameters list 56, such as “sleep”, in order to essentially instantaneously have the automated system display to him display screen 50; he can then select another parameter from the parameters list 56, other than “sleep”, and again essentially instantaneously have the automated system display to him another display screen, for that parameter.

The invention may be appreciated with reference to the following Examples, without the invention being limited thereto.

### Comparative Example 1

For conventional outpatient care, typically, a patient comes into the mental health professional's office and during the visit with the doctor, is queried regarding the level of the symptoms and problems that the doctor is treating, the course of these symptoms and problems during the time period between the current visit and the last visit with the doctor.

Unfortunately if the doctor is seeing the patient biweekly, monthly or every 3 months, the patient's recollection of the level and course of the symptoms over this time period away from the doctor is usually very general and vague and the patient's recollection is not entirely accurate, which posses difficulty for the doctor to make a clear assessment of the patient's functioning and progress.

### Comparative Example 1A

When a psychiatric patient is hospitalized, ratings of the patient's important symptoms and parameters are monitored and charted on an hourly or 8-hour period. When the doctor visits the patient he picks up the chart and sees a series of data points on a graph that inform him of the patient's progress. This information is crucial for the doctor to make informed clinical decisions about the hospitalized patient.

### Inventive Example 1

In this example, the automated system 100 is programmed with a list of a number (such as 60) parameters (such as, e.g., Sleep, Mood, Overall Functioning, Energy, Anger/Guilt, Anxiety, etc.), and the system presents the mental health professional with this list of parameters from which list he selects a subset (such as 12 parameters) to track for a particular patient.

The system's user (such as a physician) is therefore able to select a customized set of parameters for each patient. The system presents the parameters to the physician in a form from which selection is easy for the physician, such as in a form of a simple menu of choices.

### Inventive Example 1A

The parameters also are customizable according to the patient's age (child, adolescent, adult).

### Inventive Example 1B

In this example, any parameter also can be added by the mental health professional to the list (such as the list of Example 1) of parameters to be monitored.

### Inventive Example 2

In this example, the system 100 stores patient data so that the data is accessible by all authorized professionals who are providing services to the patient, such as, e.g., the patient's psychiatrist, psychologist, social worker, etc., so that coordinate care can be provided.

### Inventive Example 2A

In this example, in the case of a child whose behavior or performance is being reported on by teacher, in addition to the child's doctor accessing the data, the child's parent is able to access the data to see how the child is doing.

### Inventive Example 3

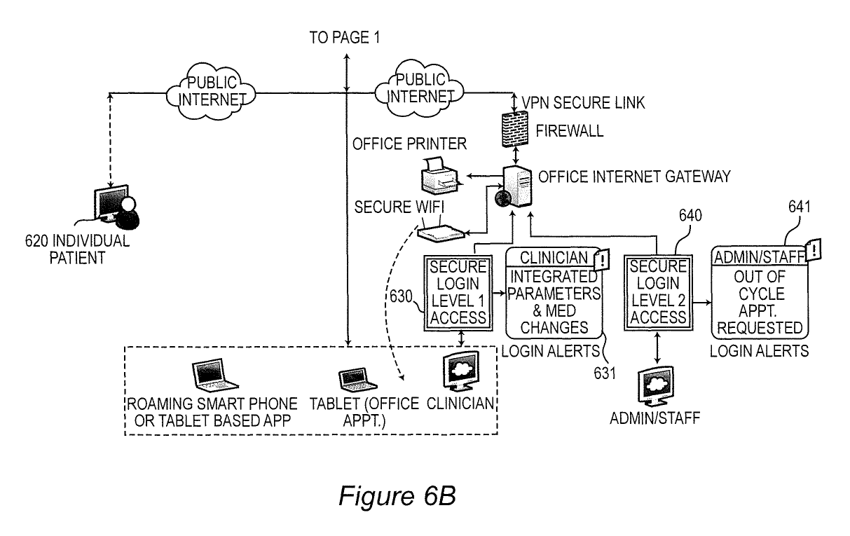

In this example, an inventive Questionnaire and Survey Report System 600 (FIG. 6) is constructed. System 600 comprises a Medication Database 601, Survey Questions and Reports 602, encrypted patient records 603, a remote database and application server 604. System 600 comprises a distribution scheduler engine 605, a response and alert parser 606, a module for simple reports (texts/emails) 607, a module for medical statistics and medical lookup and interaction parser 608, a module for detailed reports 609, a module to create individual patient survey 610, a module to create survey profiles 611, a module to edit patient medication(s) 612, and modules 613, 614 categorized as administrative/staff including a module to add/edit survey questions 613 and a module to edit patient data (name, insurance, etc.) 614.

System 600 includes a secure link 615 between system components 615 and system components 617.

System 600 comprises an electronic device 620 used by an individual patient. It should be appreciated that the computer screen in FIG. 6 is merely illustrative and that electronic device 620 may be any electronic device, including but not limited to personal computers, laptop computers, mobile devices, smart phones, etc.

System 600 comprises a secure login level 1 access 630 in communication with the clinician, for the system to output Integrated Parameters and Medication Changes 631 including login alert(s); and a secure login level 2 access 640 in communication with administrative staff, for the system to output Out of Cycle Appointment Requested 631 including login alert(s) to administrative staff.

### Inventive Example 4

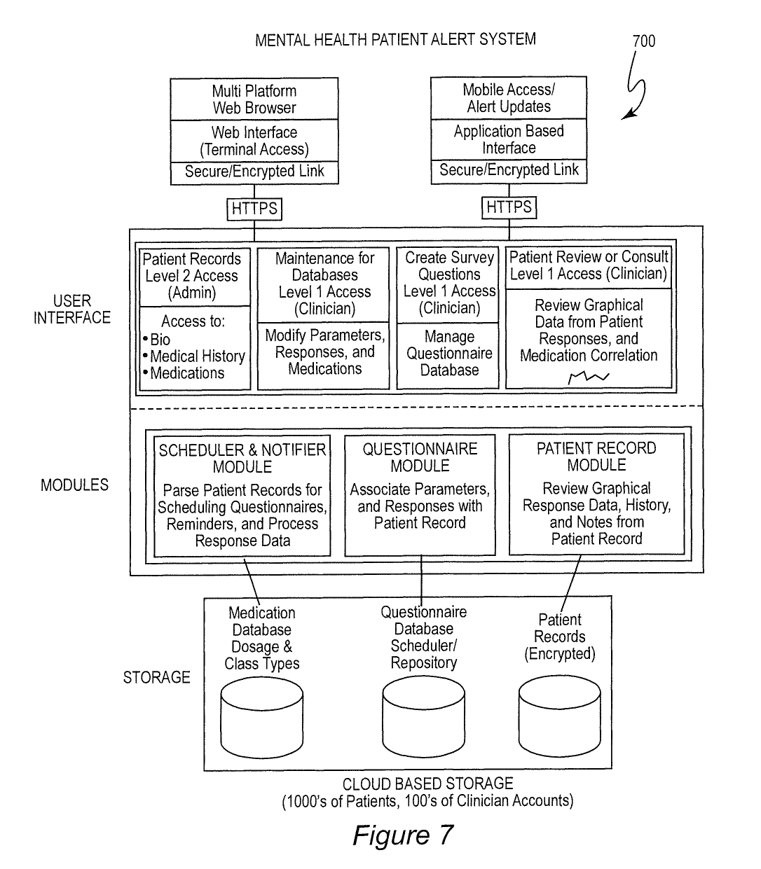

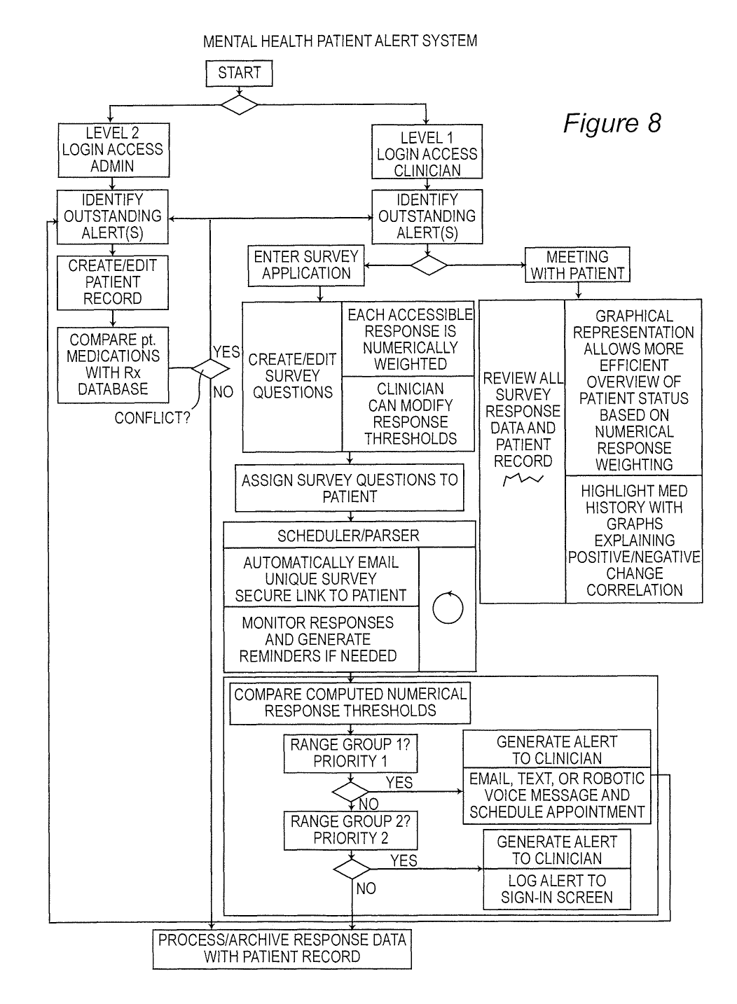

In this example, an inventive mental health patient alert system 700 (FIG. 7) is constructed. System 700 performs the steps in the flow chart of FIG. 8.

### Inventive Example 5

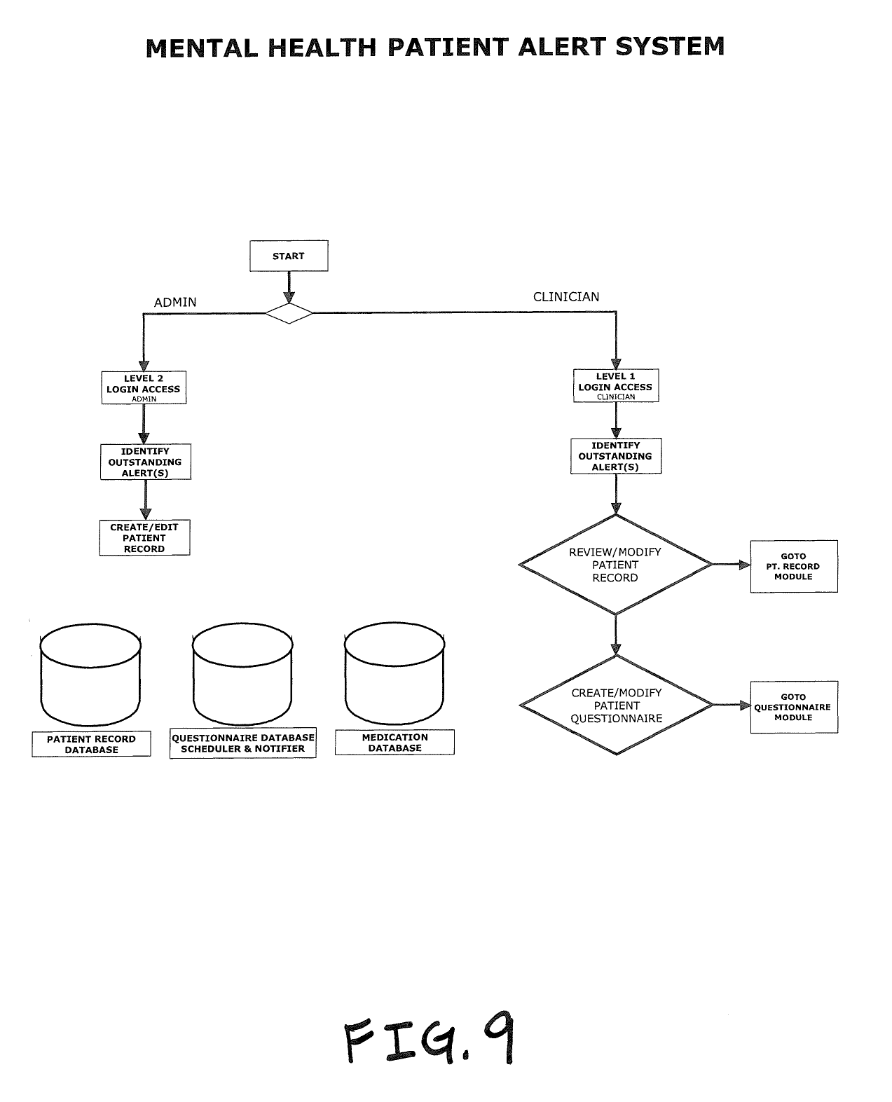

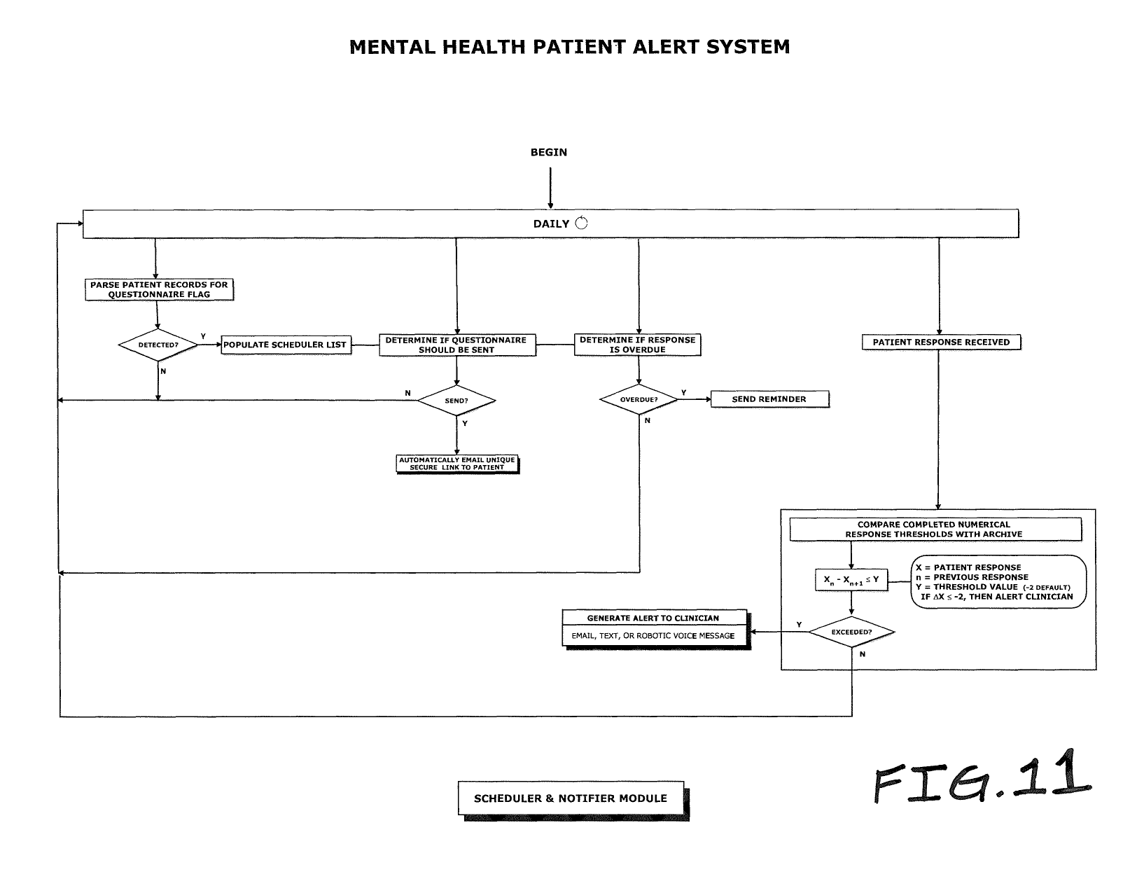

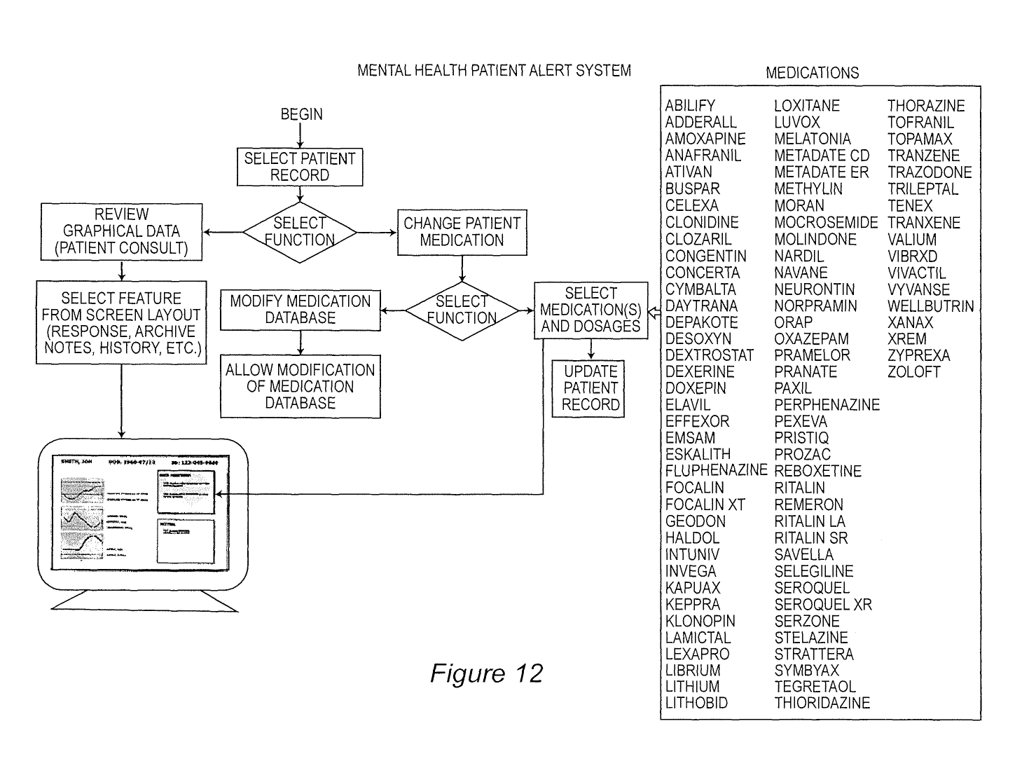

A system is constructed that performs the steps according to the flow chart of FIG. 9, and that comprises a user interface, a Scheduler & Notifier Module (see FIG. 11), a Questionnaire Module (see FIG. 10), a Patient Record Module (see FIG. 12), and storage (see FIG. 7).

The inventive system provides a customized survey to a patient onto an electronic device of the patient. Examples of sample questionnaire screens generated by an inventive system in this example are shown in FIG. 13.

The computerized system of this example is particularly useful to a doctor to see a graph of a parameter on which survey responses have been collected from his patient between office visits and onto which graph the automated system has overlaid a history of medication changes.

Advantageously, this system can be scaled to any practice requiring a longer term follow up of a patient, be it General Practitioner, or Medical Specialist.

### Inventive Example 6

In this example, the inventive computerized system is constructed to send an alarm to the mental health professional when the inventive system detects that an alarm threshold has been exceeded, and also to link the patient to an “Advisor” (Artificial Intelligence (AI)) web page for immediate patient support. An example of an AI web page is a third party online psychiatric support page.

### Inventive Example 7

In this example, the inventive computerized system is constructed to include parameters used by a mental health professional in connection with Post-Traumatic Stress Disorder (PTSD), and the system automatically monitors the patient survey responses and if a predetermined alarm threshold is found, the system generates an alarm and based on the alarm sends an alert to the patient's physician.

It will be appreciated that variations and modifications from the embodiments set forth above may be made without departing from the spirit of the invention, and that such modifications are to be considered within the present invention.

What we claim as our invention is:

1. A method for a detailed monitoring of a mental health status, during an interim period between visits to a mental health professional, of a caseload of individual patients who are outpatients of the mental health professional, comprising steps performed by an automated system comprising at least one computer or machine, of:
receiving into the automated system, via a portal accessed by the mental health professional, a schedule for each patient of a frequency at which the automated system is to send a probe to the patient;
maintaining, by the automated system, a table in which each patient in the caseload has an entry for the frequency at which the automated system is to send a probe to the patient;
updating the table, performed by the automated system, based on the schedule received in the receiving step;
according to the sending-frequency table, selectively sending, performed by the automated system, a probe including at least one question and a set of predefined answers each of which is selectable, to a remote device associated with a patient, and repeating the selectively sending step for other patients within the caseload.

2. The method of claim 1, further comprising a step, performed by the automated system, of receiving back from the patient an answered probe.

3. The method of claim 2, further comprising a step, performed by the automated system, of storing the answered probe.

4. The method of claim 3, further comprising a step, performed by the automated system, of receiving a request from the mental health professional to view a summary for a patient, wherein the summary is based on at least one answered probe received back from the patient.

5. The method of claim 2, further comprising a step, performed by the automated system, of screening the answered probe against a predetermined alarm criterion, wherein the screening is performed in real-time upon receiving back the answered probe.

6. The method of claim 5, further comprising a step, performed by the automated system, of, when the predetermined alarm criterion is found in the answered probe, immediately transmitting an alarm.

7. The method of claim 1, further comprising steps performed by the automated system of providing, for a particular patient, a menu of selectable tracking parameters to the mental health provider, and receiving as input from the mental health provider a selection of a subset of the provided parameters, followed by storing the subset of parameters in a file for the patient, and when sending probes to the patient, including only questions based on the subset of parameters for the patient.

8. The method of claim 1, further comprising steps performed by the automated system of:
storing, in a patient names database, names of patients of the mental health professional;
storing, for each patient in the patient names database, medications and changes data;
storing, for each patient in the patient names database, medication list data comprising a medication list;
storing, for each patient in the patient names database, a parameters list which comprises a set of parameters selected by the mental health professional and which are to be addressed by the probes sent to the patient;
storing, for each patient in the patient names database, parameters data which resulted from probes sent to the patient;
receiving a selection from the mental health professional of a particular selected patient name and a particular selected parameter, followed by generating a screen display for the selected patient name depicting a plotted graph for the selected parameter.

9. The method of claim 8, comprising a step, performed by the automated system, of displaying medication change data on the display screen wherein each displayed medication change data display is oriented along a time-axis of the display screen to appear exactly on the time-axis according to a date of the medication change being displayed.

10. The method of claim 1, comprising a step performed by the automated system, of sending an alert to the physician when a patient has had an alarm generated, wherein the alert sent to the physician either identifies the patient or permits the physician to gain access to the identity of the patient.

11. A mental health patient alert method performed by a computerized mental health patient alert system, comprising steps, performed by the system, of:
surveying a patient according to a survey schedule wherein the patient is surveyed between office visits;
collecting a set of responses by the patient obtained through the surveying step;
storing patient-specific historical data and current data for medications taken by the patient;
based on the survey responses collected from the patient for a first parameter and on the stored patient-specific data, plotting a patient-specific graph covering a period of time for the first parameter and overlaying at least one medication change indicator onto the plotted graph;
outputting the plotted patient-specific graph for the first parameter with the overlaid medication change indicator to an electronic device that is viewed by a mental health professional who is responsible for the patient.

12. The method of claim 11, comprising a step performed by the automated system, of sending an alert to the physician when a patient has had an alarm generated, wherein the alert sent to the physician either identifies the patient or permits the physician to gain access to the identity of the patient.
